(19) United States
(12) Patent Application Publication
(10) Pub. No.: US 2021/0155353 A1
(43) Pub. Date: May 27, 2021

(54) AUGMENTED PRESSURIZED SPACESUIT

(71) Applicant: Eric Miller, San Francisco, CA (US)

(72) Inventor: Eric Miller, San Francisco, CA (US)

(21) Appl. No.: 17/070,614

(22) Filed: Oct. 14, 2020

Related U.S. Application Data
(60) Provisional application No. 62/939,153, filed on Nov. 22, 2019.

(51) Int. Cl. B64G 6/00; F15B 15/14

(52) U.S. Cl. CPC B64G 6/00; F15B 15/149

(57) ABSTRACT

A pressurized spacesuit includes a pressure retention garment. The pressure retention garment includes a joint that pivotally couples a first portion of the pressure retention garment and a second portion of the pressure retention garment. The pressure retention garment further includes a bearing that rotatably couples one of the first and second portions of the pressure retention garment and the joint. An exo-muscular system is connected to the pressure retention garment. The exo-muscular system includes a linear actuator coupled to the bearing.

### CROSS-REFERENCE TO RELATED APPLICATION

The present application is related and has right of priority to U.S. Provisional Application No. 62/939,153 filed on Nov. 22, 2019, which is incorporated by reference in its entirety.

### FIELD OF THE INVENTION

The present subject matter relates generally to spacesuits.

### BACKGROUND OF THE INVENTION

Astronauts frequently wear spacesuits. For instance, astronauts don spacesuits for extra-vehicular activity. Within the spacesuits, the astronauts have a breathable atmosphere necessary for survival outside of the vehicle.

Known spacesuits suffer from various drawbacks. One drawback is that spacesuits generally operate at a near-full oxygen condition with a partial Earth atmospheric pressure, ranging from four pounds per square inch (4 psi) to eight pounds per square inch (8 psi). Thus, when donning the spacesuits, wearers are required to “wash out” or “pre-breath” pure oxygen to expel nitrogen from the body and thereby avoid decompression sickness occurring during the transition from a relatively high-pressure environment to the relatively low-pressure environment within the spacesuits. Such transitioning is time intensive and inconvenient. In addition, such transitioning prevents rapid donning of the spacesuits.

Another drawback in known spacesuits is limited mobility. The materials and construction of known space suits generally requires the wearers to generate a significant torque to articulate joints and maneuver appendages of the spacesuits. The significant torques fatigue the wearers and thus reduce the energy that the wearers can devote to other valuable tasks.

A spacesuit that address the above recited drawbacks would be useful.

### BRIEF DESCRIPTION OF THE INVENTION

Aspects and advantages of the invention will be set forth in part in the following description, or may be apparent from the description, or may be learned through practice of the invention.

In an example embodiment, a pressurized spacesuit includes a pressure retention garment. The pressure retention garment includes a joint that pivotally couples a first portion of the pressure retention garment and a second portion of the pressure retention garment. The pressure retention garment further includes a bearing that rotatably couples one of the first and second portions of the pressure retention garment and the joint. An exo-muscular system is connected to the pressure retention garment. The exo-muscular system includes a first linear actuator and a second linear actuator. A first end portion of the first linear actuator is positioned at and coupled to the bearing. A first end portion of the second linear actuator is positioned at and coupled to the bearing. The first end portion of the first linear actuator is spaced from the first end portion of the second linear actuator on the bearing.

In a first example aspect, the first and second linear actuators include pneumatic artificial muscles.

In a second example aspect, the first end portions of the first and second linear actuators are pivotally coupled to the bearing.

In a third example aspect, the pressure retention garment further includes an additional bearing. A second end portion of the first linear actuator is positioned at and coupled to the additional bearing. A second end portion of the second linear actuator is positioned at and coupled to the additional bearing. The second end portion of the first linear actuator is spaced from the second end portion of the second linear actuator on the additional bearing.

In a fourth example aspect, the first and second portions of the pressure retention garment are tubular.

In a fifth example aspect, the bearing is annular.

In a sixth example aspect, the pressure retention garment is configured to contain a full Earth atmospheric pressurization.

In a seventh example aspect, the first and second portions of the pressure retention garments include a fabric shell.

In an eighth example aspect, the first and second portions of the pressure retention garment include a plastic shell.

In a ninth example aspect, the first end portion of the first linear actuator is positioned opposite the first end portion of the second linear actuator on the bearing.

In a tenth example aspect, the first portion of the pressure retention garment is an upper arm casing, the second portion of the pressure retention garment is a lower arm casing, and the joint is an elbow joint.

In an eleventh example aspect, the first portion of the pressure retention garment is an upper leg casing, the second portion of the pressure retention garment is a lower leg casing, and the joint is a knee joint.

In a twelfth example aspect, the first and second linear actuators are positioned radially-equidistant from an axial centerline of the first portion of the pressure retention garment.

In a thirteenth example aspect, the pressure retention garment further includes an additional bearing. A second end portion of the first linear actuator is coupled to the additional bearing. The additional bearing rotatably couples the other of the first and second portions of the pressure retention garment and the joint.

In a fourteenth example aspect, a second end portion of the first linear actuator is coupled directly to the second portion of the pressure retention garment.

In a fifteenth example aspect, the pressure retention garment includes an inner bladder and an outer fabric restraint web.

In a sixteenth example aspect, the first and second portions of the pressure retention garment are micrometeoroid, puncture, impact, heat and fire-resistant.

In a seventeenth example aspect, the exo-muscular system further includes a controller and a plurality of sensors. The controller is configured to operate the first and second linear actuators based at least in part on one or more signals from the plurality of sensors.

In an eighteenth example aspect, the plurality of sensors include one or more of an electromyographic monitoring sensor, a pulmonary metabolic sensor, a thermal balance sensor, a force sensor, and an inertial sensor.

In a nineteenth example aspect, the plurality of sensors is configured to measure motion, limb pose, and joint angles of the pressurized spacesuit.

In a twentieth example aspect, the controller is configured to calculate a target stroke length of each of the first and second linear actuators based at least in part on the measured motion, limb pose, and joint angles of the pressurized spacesuit.

In a twenty-first example aspect, the plurality of sensors is integrated into the pressure retention garment at an inner surface of the pressure retention garment.

In a twenty-second example aspect, the exo-muscular system further includes a compressed gas tank and a control valve. The compressed gas tank is in fluid communication with the first and second linear actuators. The control valve is operable to regulate a flow of gas from the compressed gas tank to one or both of the first and second linear actuators.

In a twenty-third example aspect, the control valve is a three-position solenoid gas valve or a digital proportional pressure regulator.

In a twenty-fourth example aspect, the exo-muscular system further comprises plastic tubing connected to an port of the first or second linear actuators.

In a twenty-fifth example aspect, the plastic tubing is constructed of polyurethane, polyamide, or polyvinylchloride, and is encased within a protective sleeve.

In a twenty-sixth example aspect, the exo-muscular system further includes a plurality of gas tanks coupled to an outlet of the first and second linear actuators. The plurality of gas tanks is configured to collect gas expelled from the first and second linear actuators.

Each of the example aspects recited above may be combined with one or more of the other example aspects recited above in certain embodiments. For instance, all of the twenty-six example aspects recited above may be combined with one another in some embodiments. As another example, any combination of two, three, four, five, or more of the twenty-six example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of a pressurized spacesuit according to an example embodiment of the present subject matter.

FIG. 2 is a front elevation view of the example pressurized spacesuit of FIG. 1 with various shell portions of the example pressurized spacesuit removed.

FIG. 3 is a front elevation view of an arm of the example pressurized spacesuit of FIG. 2.

FIG. 4 is a front elevation view of the arm of the example pressurized spacesuit of FIG. 2 with certain components of a pressure retention garment removed.

FIG. 5 is a top, plan view of the arm of the example pressurized spacesuit of FIG. 4.

FIG. 6 is a rear, elevation view of the arm of the example pressurized spacesuit of FIG. 4.

FIG. 7 is an exploded view of the arm of the example pressurized spacesuit of FIG. 4.

FIG. 8 is a front elevation view of a leg of the example pressurized spacesuit of FIG. 2.

FIG. 9 is an exploded view of the leg of the example pressurized spacesuit of FIG. 8.

FIG. 10 is a schematic view of certain components of the example pressurized spacesuit of FIG. 1.

FIG. 11 is a schematic view of a portion of a garment of the example pressurized spacesuit of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present subject matter provides a pressurized spacesuit 100. As discussed in greater detail below, pressurized spacesuit 100 includes various features for providing a wearer of pressurized spacesuit 100 with a comfortable experience. For instance, pressurized spacesuit 100 may include a strength-augmenting robotic system, also referred to herein as an exo-muscular system, for facilitating movement, e.g., of a torso, limbs or other suitable portions of pressurized spacesuit 100. The exo-muscular system may include soft, rigid or semi-rigid actuators, such as pneumatic McKibben gas muscles, e.g., assembled in a bi-articular configuration and/or integrated into the pressurized spacesuit 100. The bi-articular configuration may be implemented such that each appendage has a set of antagonistic actuators. A garment of the pressurized spacesuit 100, which may include a liquid-cooled layer in direct contact with the wearer's skin, may include embedded sensors configured to track the wearer's motion and/or establishing limits for the exo-muscular system. Pressurized spacesuit 100 may also be charged with an atmosphere at a partial or a full Earth atmosphere operating pressure, e.g., that allows the wearer to don pressurized spacesuit 100 without onerous pre-breathing to expel nitrogen. The exo-muscular system may also provide sufficient actuation force to overcome suit rigidity that results from internal pressurization at the partial or full Earth atmosphere operating pressures.

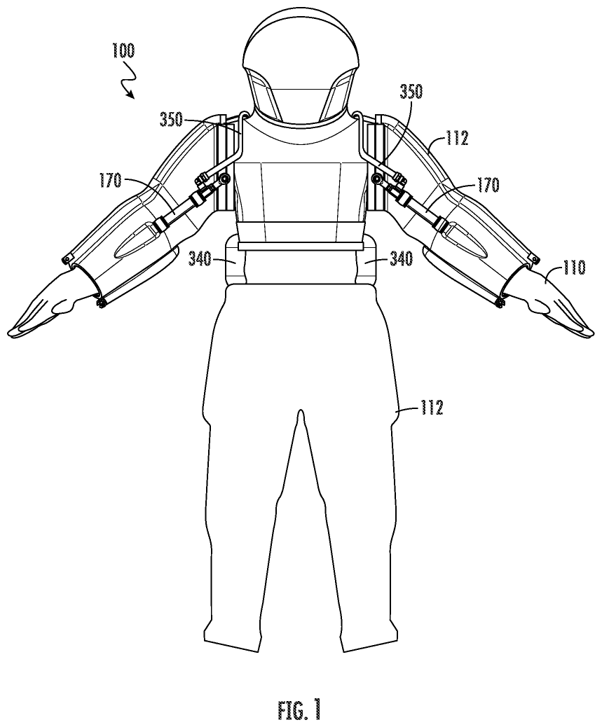

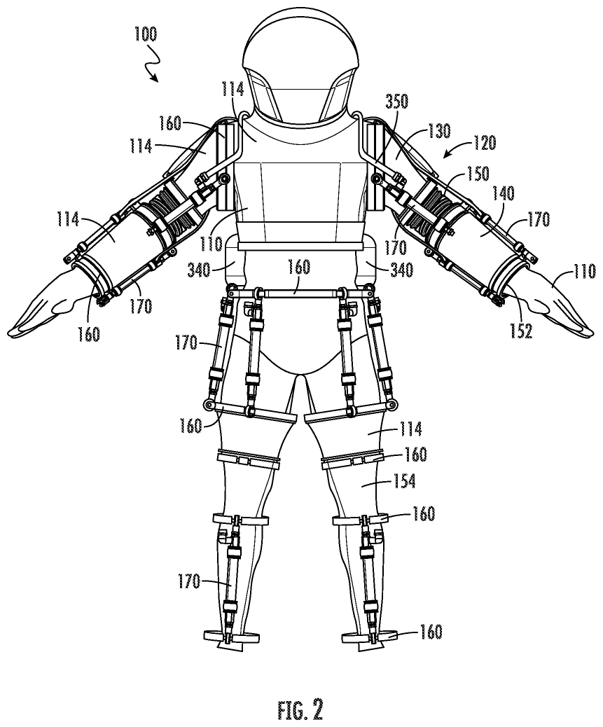

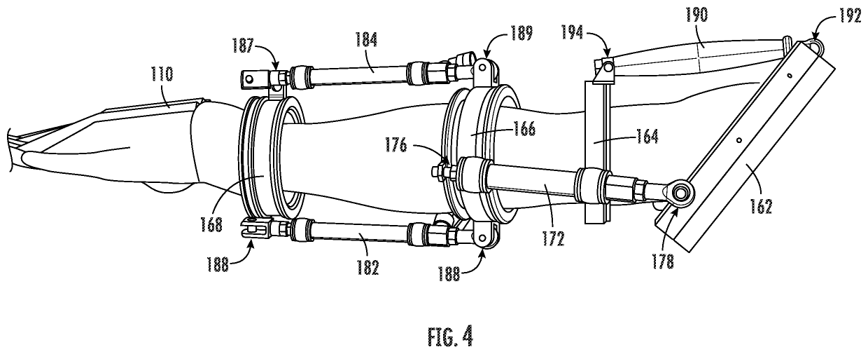

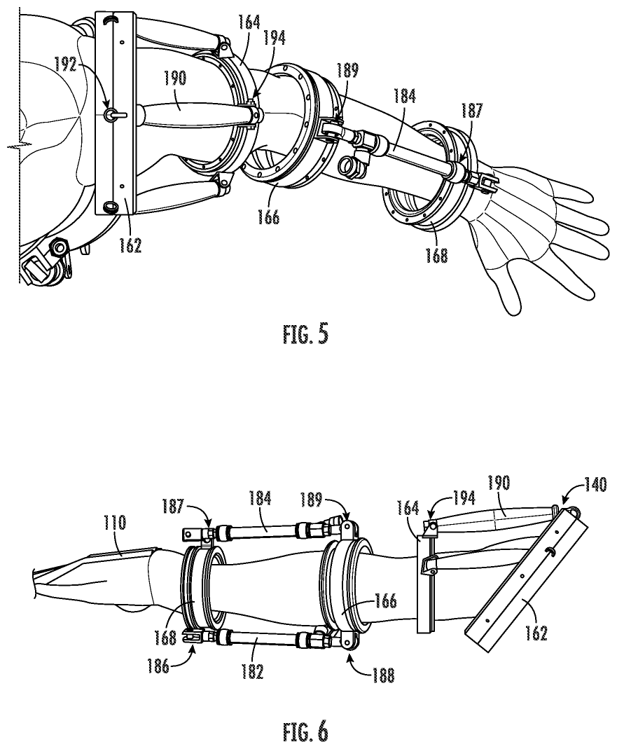

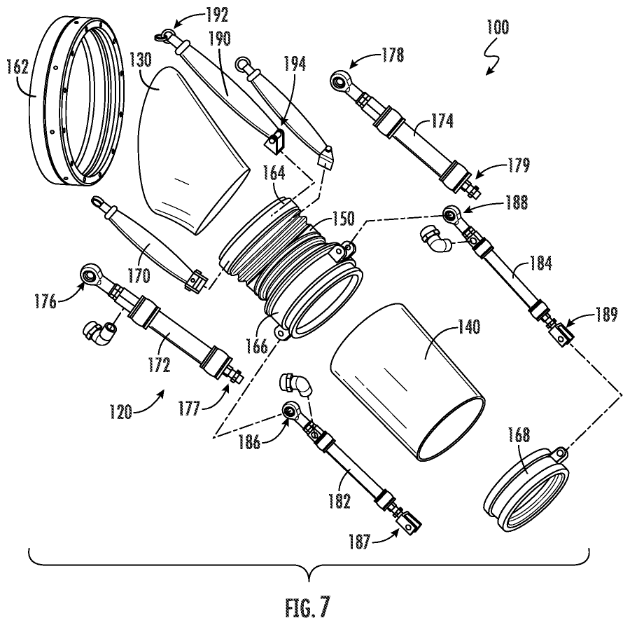

Turning now to FIGS. 1 through 9, pressurized spacesuit 100 may include a garment 110 with a pressure retention layer 116 (FIG. 11). Thus, garment 110 may be a pressure retention garment, and garment 110 may be configured to contain an atmosphere for a wearer of pressurized spacesuit 100. In particular, an interior of garment 110 may be charged with an atmosphere, such air, pure oxygen, a mixture that includes oxygen and nitrogen, etc. A material or fabric of the pressure retention layer 116 in garment 110 may be impermeable to the atmosphere within garment 110. Thus, pressure retention layer 116 of garment 110 may be configured as a bladder to contain the atmosphere for the wearer of pressurized spacesuit 100. Garment 110 may also include an outer fabric restraint web 118, e.g., that assist with containing or holding a shape of pressure retention layer 116 of garment 110 when garment 110 is charged with an atmosphere.

Garment 110 may be charged with an atmosphere at a suitable pressure. For example, garment 110 may be charged with an atmosphere at a full Earth atmospheric pressure. Thus, garment 110 may be charged with an atmosphere at about fourteen and seven-tenths pounds per square inch (14.7 psi). As used herein, the term about means within ten percent of the stated pressure when used in the context of pressures. As may be seen from the above, garment 110 may be configured to contain a full Earth atmospheric pressurization.

By containing an atmosphere at a full Earth atmospheric pressure, ease of using pressurized spacesuit 100 is greatly facilitated relative to known spacesuits. In particular, known spacesuits operate with atmospheres at pressures well below full Earth atmospheric pressure, generally within a range no less than four pounds per square inch (4 psi) and no greater than eight pounds per square inch (8 psi). Thus, such known spacesuits require tedious and inconvenient pre-breathing to expel nitrogen. Conversely, pressurized spacesuit 100 may not require pre-breathing to expel nitrogen prior to donning pressurized spacesuit 100.

Pressurized spacesuit 100 may also include a casing 112 that at least partially, e.g., completely, encloses garment 110. Casing 112 may be formed of or with a suitable protective material, e.g., a micrometeoroid, puncture, impact, heat and/or fire-resistant material. As an example, casing 112 may include an outer hard shell. Casing 112 may protect garment 110, e.g., from punctures, tearing, burns, etc. In certain example embodiments, casing 112 may be a fabric, shell, etc. that has suitable mechanical properties for protecting garment 110.

Pressurized spacesuit 100 also includes an exo-muscular system 120. Exo-muscular system 120 is coupled to garment 110. Exo-muscular system 120 is operable to assist movement of a user wearing pressurized spacesuit 100. For instance, exo-muscular system 120 may augment the strength and/or motion of the wearer of pressurized spacesuit 100, e.g., to reduce fatigue associated with wearing pressurized spacesuit 100. In particular, exo-muscular system 120 may facilitate movement of pressurized spacesuit 100 despite garment 110 being charged with an atmosphere at a full Earth atmospheric pressure. Thus, exo-muscular system 120 may assist a wearer with overcoming the stiffness of garment 110 when garment 110 is charged with an atmosphere at a full Earth atmospheric pressure.

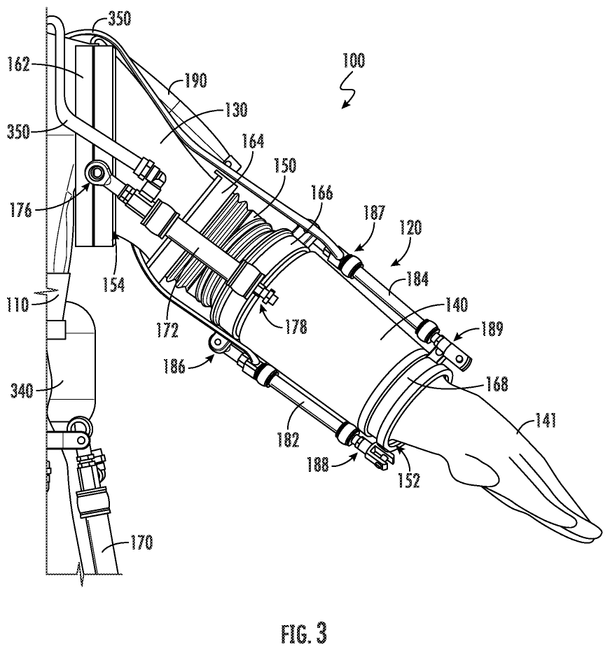

Garment 110 may include a plurality of segments or portions 114. The various portions 114 of garment 110 may be tubular. Thus, a wearer of pressurized spacesuit 100 may insert a limb, a torso, etc. into a respective portion 114 of garment 110. Turning to FIGS. 3 through 7, garment 110 may include a first portion 130 and a second portion 140. First portion 130 may correspond to an upper arm portion, and second portion 140 may correspond to a lower arm portion. Thus, e.g., first portion 130 may be sized and configured for receipt of an upper arm of a wearer, and second portion 140 may be sized and configured for receipt of a lower arm of the wearer.

First and second portions 130, 140 may be, e.g., pivotally, coupled together with a joint 150. In particular, joint 150 may couple first portion 130 to second portion 140 such that second portion 140 is pivotable relative to first portion 130 at joint 150. Joint 150 may correspond to an elbow joint. Thus, joint 150 may be sized and configured for receipt of an elbow of the wearer. Joint 150 may include a concertinaed material to facilitate pivotally coupling first and second portions 130, 140 at joint 150.

Garment 110 may also include a plurality of bearings 160 that rotatable couple the various portions of garment 110 to one another. For example, garment 110 may include a first bearing 162, a second bearing 164, a third bearing 166, and a fourth bearing 168. First bearing 162 may rotatably couple first portion 130 to another portion of garment 110. For example, first bearing 162 may rotatably couple first portion 130 to a torso portion 131 of garment 110 when first portion 130 is the upper arm portion. Second bearing 164 may rotatably couple first portion 130 to joint 150, and third bearing 166 may rotatably couple second portion 140 to joint 150. For example, second bearing 164 may rotatably couple first portion 130 to an elbow joint of garment 110 and third bearing 166 may rotatably couple second portion 140 to the elbow joint of garment 110 when joint 150 is the elbow joint. Fourth bearing 168 may rotatably couple second portion 140 to another portion of garment 110. For example, fourth bearing 168 may rotatably couple second portion 140 to a hand portion 141 of garment 110 when second portion 140 is the lower arm portion.

Bearings 160 may be annular. Thus, e.g., a limb or torso of the wearer of garment 110 may extend through bearings 160 within garment 110. By rotatably coupling portions of garment 110 to each other, bearing 160 are configured to permit the wearer of pressurized spacesuit 100 to rotate the portions of garment 110 relative to each other. For example, first bearing 162 may allow first portion 130 to rotate relative the torso portion 131 of garment 110 when first portion 130 is the upper arm portion. As another example, second bearing 164 may allow first portion 130 to rotate relative joint 150, and/or third bearing 166 may allow second portion 140 to rotate relative joint 150. Fourth bearing 168 may allow the hand portion 141 of garment 110 to rotate relative second portion 140 when second portion 140 is the lower arm portion.

Exo-muscular system 120 may include a plurality of linear actuators 170, including a first linear actuator 172 and a second linear actuator 174. Linear actuators 170 may be pneumatic artificial muscles. Thus, e.g., linear actuators 170 may be connected to a pressurized gas source, and pressurized gas, such as air, may contract linear actuators 170. In alternative example embodiments, linear actuators 170 may be hydraulic, mechanical, electric, etc. In certain example embodiments, the gas used to operate linear actuators 170 may be the same as the atmosphere within the interior of garment 110. Thus, e.g., the gas used to operate linear actuators 170 may be air, pure oxygen, a mixture that includes oxygen and nitrogen, etc.

Linear actuators 170 are operable to contract and/or expand in order to assist movement of the wearer of pressurized spacesuit 100. Thus, linear actuators 170 may be connected to garment 110. For instance, each end portion of linear actuators 170 may be connected or coupled to a different portion of garment 110. By contracting and/or expanding, linear actuators 170 may actuate joints of pressurized spacesuit 100 and facilitate movement of the wearer of pressurized spacesuit 100. The end portions of linear actuators 170 may be rotatably or pivotally mounted to garment 110, e.g., using devises, eye-bolts, polyethylene (PE) braided lines, etc.

As an example, first linear actuator 172 may extend longitudinally between a first end portion 176 and a second end portion 177, and second linear actuator 174 may extend longitudinally between a first end portion 178 and a second end portion 179. First end portion 176 of first linear actuator 172 may be positioned at and coupled to first bearing 162, and second end portion 177 of first linear actuator 172 may be positioned at and coupled to third bearing 166. Similarly, first end portion 178 of second linear actuator 174 may be positioned at and coupled to first bearing 162, and second end portion 179 of second linear actuator 174 may be positioned at and coupled to third bearing 166. By contracting and/or expanding, first and second linear actuators 172, 174 may actuate joint 150 such that first and second portions 130, 140 of garment 110 pivot relative to each other at joint 150. In alternative example embodiments, second end portions 177, 179 of first and second linear actuators 172, 174 may be coupled to casing 112 (FIG. 1) or another component connected to casing 112.

As another example, linear actuators 170 may also include a third linear actuator 182 and a fourth linear actuator 184. Third linear actuator 182 may extend longitudinally between a first end portion 186 and a second end portion 187, and fourth linear actuator 184 may extend longitudinally between a first end portion 188 and a second end portion 189. First end portion 186 of third linear actuator 182 may be positioned at and coupled to third bearing 166, and second end portion 187 of third linear actuator 182 may be positioned at and coupled to fourth bearing 168. Similarly, first end portion 188 of fourth linear actuator 184 may be positioned at and coupled to third bearing 166, and second end portion 189 of fourth linear actuator 184 may be positioned at and coupled to fourth bearing 168. By contracting and/or expanding, third and fourth linear actuators 182, 184 may actuate a joint 152, e.g., a wrist joint.

As yet another example, linear actuators 170 may also include a fifth linear actuator 190. Fifth linear actuator 190 may extend longitudinally between a first end portion 192 and a second end portion 194. First end portion 192 of fifth linear actuator 190 may be positioned at and coupled to first bearing 162, and second end portion 194 of fifth linear actuator 190 may be positioned at and coupled to second bearing 164. By contracting and/or expanding, fifth linear actuator 190 may actuate a joint 154, e.g., a shoulder joint.

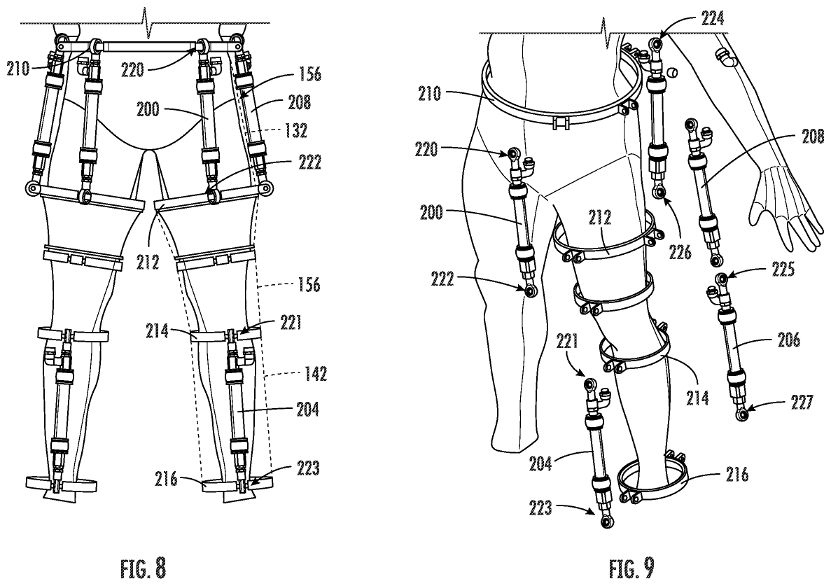

While described above in the context of one arm of pressurized spacesuit 100, it will be understood that the other arm of pressurized spacesuit 100 may be constructed in the same or similar manner. As described in greater detail below, exo-muscular system 120 may also be configured to actuate legs of pressurized spacesuit 100. Referring to FIGS. 8 and 9, garment 110 may include a third portion 132 and a fourth portion 142. Third portion 132 may correspond to an upper leg portion, and fourth portion 142 may correspond to a lower leg portion. Thus, e.g., third portion 132 may be sized and configured for receipt of an upper leg of a wearer, and fourth portion 142 may be sized and configured for receipt of a lower leg of the wearer.

Third and fourth portions 132, 142 may be, e.g., pivotally, coupled together with a joint 156. In particular, joint 156 may couple third portion 132 to fourth portion 142 such that fourth portion 142 is pivotable relative to third portion 132 at joint 156. Joint 156 may correspond to a knee joint. Thus, joint 156 may be sized and configured for receipt of a knee of the wearer.

Linear actuators 170 may also include a sixth linear actuator 200, a seventh linear actuator 202, an eighth linear actuator 204, and a ninth linear actuator 206, and tenth linear actuator 208. Garment 110 may also include a fifth bearing 210, a sixth bearing 212, a seventh bearing 214, and an eight bearing 216.

Sixth linear actuator 200 may extend longitudinally between a first end portion 220 and a second end portion 222, and seventh linear actuator 202 may extend longitudinally between a first end portion 224 and a second end portion 226. First end portion 220 of sixth linear actuator 200 may be positioned at and coupled to fifth bearing 210, and second end portion 222 of sixth linear actuator 200 may be positioned at and coupled to sixth bearing 212. Similarly, first end portion 224 of seventh linear actuator 202 may be positioned at and coupled to fifth bearing 210, and second end portion 226 of seventh linear actuator 202 may be positioned at and coupled to sixth bearing 212. By contracting and/or expanding, sixth and seventh linear actuators 200, 202 may actuate a hip joint of garment 110.

Eighth linear actuator 204 may extend longitudinally between a first end portion 221 and a second end portion 223, and ninth linear actuator 208 may extend longitudinally between a first end portion 225 and a second end portion 227. First end portion 227 of eighth linear actuator 204 may be positioned at and coupled to seventh bearing 214, and second end portion 225 of eighth linear actuator 204 may be positioned at and coupled to eighth bearing 216. Similarly, first end portion 225 of ninth linear actuator 206 may be positioned at and coupled to seventh bearing 214, and second end portion 227 of ninth linear actuator 206 may be positioned at and coupled to eighth bearing 216. By contracting and/or expanding, eighth and ninth linear actuators 204, 206 may actuate joint 154 such that third and fourth portions 132, 142 of garment 110 pivot relative to each other at joint 154.

As yet another example, tenth linear actuator 208 may extend between fifth bearing 210 and sixth bearing 212. By contracting and/or expanding, tenth linear actuator 208 may actuate a joint 156, e.g., a hip joint.

Groups (e.g., two or more) of linear actuators 170 may be positioned in a complementary manner. For instance, a pair of linear actuators 170 may be positioned antagonistic to each other. Thus, one of a pair of linear actuators 170 may be positioned opposite the other of the pair of linear actuators 170 on garment 110. Arranging linear actuators 170 in antagonistic pairs may assist linear actuators 170 for each corresponding limb of pressurized spacesuit 100 with amplifying flexion and extension capabilities of rigid pressure joints within pressurized spacesuit 100.

As an example, first end portion 176 of first linear actuator 172 may be spaced from first end portion 178 of second linear actuator 174 on first bearing 162. Similarly, second end portion 177 of first linear actuator 172 may be spaced from second end portion 179 of second linear actuator 174 on third bearing 166. In particular, first end portion 176 of first linear actuator 172 may be positioned opposite first end portion 178 of second linear actuator 174 on first bearing 162, and/or second end portion 177 of first linear actuator 172 may be positioned opposite second end portion 179 of second linear actuator 174 on third bearing 166. In certain example embodiments, first and second linear actuators 172, 174 are positioned radially-equidistant from an axial centerline of first portion 130.

As another example, first end portion 186 of third linear actuator 182 may be spaced from first end portion 188 of fourth linear actuator 184 on third bearing 166. Similarly, second end portion 187 of third linear actuator 182 may be spaced from second end portion 189 of fourth linear actuator 184 on fourth bearing 168. In particular, first end portion 186 of third linear actuator 182 may be positioned opposite first end portion 188 of fourth linear actuator 184 on third bearing 166, and/or second end portion 187 of third linear actuator 182 may be positioned opposite second end portion 189 of fourth linear actuator 184 on fourth bearing 168. In certain example embodiments, third and fourth linear actuators 182, 184 are positioned radially-equidistant from an axial centerline of second portion 140.

As an additional example, first end portion 220 of sixth linear actuator 200 may be spaced from first end portion 224 of seventh linear actuator 202 on fifth bearing 210. Similarly, second end portion 222 of sixth linear actuator 200 may be spaced from second end portion 226 of seventh linear actuator 202 on sixth bearing 212. In particular, first end portion 220 of sixth linear actuator 200 may be positioned opposite first end portion 224 of seventh linear actuator 202 on seventh bearing 214. In certain example embodiments, sixth and seventh linear actuators 200, 202 are positioned radially-equidistant from an axial centerline of third portion 132.

As another example, first end portion 221 of eighth linear actuator 204 may be spaced from first end portion 225 of ninth linear actuator 206 on sixth bearing 214. Similarly, second end portion 223 of eighth linear actuator 204 may be spaced from second end portion 227 of ninth linear actuator 206 on seventh bearing 214. In particular, first end portion 221 of eighth linear actuator 204 may be positioned opposite first end portion 225 of ninth linear actuator 206 on eight bearing 216. In certain example embodiments, eighth and ninth linear actuators 204, 206 are positioned radially-equidistant from an axial centerline of fourth portion 142.

As may be seen from the above, linear actuators 170 may be fluidic, e.g., pneumatic, actuators. Thus, e.g., linear actuators 170 may include a central elastic tube with an interior bore and a surrounding sheath of braided fibers. Linear actuators 170 may be arranged adjacent to joints of pressurized spacesuit 100, such as a shoulder, an elbow, a hip, and/or a knee. Each joint may be driven antagonistically, e.g., by a respective pair of linear actuators 170. Linear actuators 170 may be actuated, e.g., when linear actuators 170 are gas muscles, by supplying a selected volume of gas into the interior bore of the central elastic tube, The selected volume of gas may be controlled as a function of an opening time of an associated supply valve for the linear actuator(s) 170, as discussed in greater detail below.

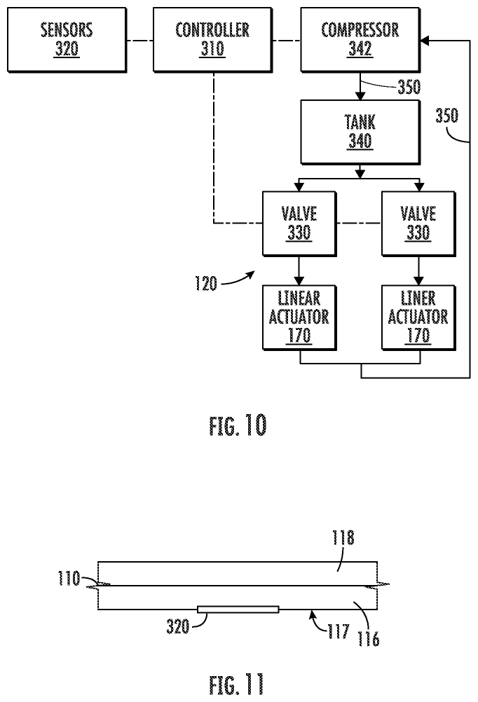

As may be seen in FIG. 10, exo-muscular system 120 may include a controller 310 and a plurality of sensors 320. Various components of exo-muscular system 120 are regulated with controller 310. Input/output (“I/O”) signals may be routed between controller 310 and various operational components of exo-muscular system 120. The components of exo-muscular system 120 may be in communication with controller 120 via one or more signal lines or shared communication busses.

Controller 310 can be any device that includes one or more processors and a memory. As an example, in some embodiments, controller 310 may be a single board computer (SBC). For example, controller 310 can be a single System-On-Chip (SOC). However, any form of controller 310 may also be used to perform the present subject matter. The processor(s) can be any suitable processing device, such as a microprocessor, microcontroller, integrated circuit, or other suitable processing devices or combinations thereof. The memory can include any suitable storage media, including, but not limited to, non-transitory computer-readable media, RAM, ROM, hard drives, flash drives, accessible databases, or other memory devices. The memory can store information accessible by processor(s), including instructions that can be executed by processor(s) to perform aspects of the present disclosure.

Controller 310 may be in communication with sensors 320, and controller 310 may be configured to operate linear actuators 170 based at least in part on one or more signals from sensors 320. Sensors 320 may one or more (e.g., all) of an electromyographic monitoring sensor, a pulmonary metabolic sensor, a thermal balance sensor, a force sensor, an inertial sensor, and a rotary encoder. Thus, sensors 320 may be configured to detect and measure one or more of motion, limb pose, and joint angles of pressurized spacesuit 100. As an example, controller 310 may receive a respective signal from each of sensors 320, and each signal from sensors 320 may correspond to a respective limb pose or joint angle for pressurized spacesuit 100 or a physiological condition of the wearer of pressurized spacesuit 100. Utilizing the signals from sensors 320, controller 310 may command contraction and/or expansion of linear actuators 170, e.g., to provide synchronous motion between exo-muscular system 120 and the wearer of pressurized spacesuit 100.

Sensors 320 may be mounted on and/or integrated into garment 110. For instance, as shown in FIG. 11, sensors 320 may be positioned at an inner surface 117 of garment 110 (e.g., at pressure retention layer 116). Inner surface 117 of garment 110 faces the interior of garment 110 and thus the wearer of pressurized spacesuit 100. By positioning sensors 320 on inner surface 117, sensors 320 may contact and/or be positioned adjacent the wearer of pressurized spacesuit 100.

Exo-muscular system 120 may also include one or more control valve(s) 330 and one or more compressed gas tanks 340, e.g., when linear actuators 170 are pneumatic linear actuators. Compressed gas tank 340 is in fluid communication with linear actuators 170. Thus, compressed gas may flow from compressed gas tank 340 to linear actuators 170, and the compressed gas from compressed gas tank 340 may operate linear actuators 170. As an example, a gas conduit 350 may fluidically connect compressed gas tank 340 and linear actuators 170. Gas conduit 350 may be any suitable conduit for flowing gas between the various components of exo-muscular system 120. For example, gas conduit 350 may be plastic tubing, such as polyurethane, polyamide, or polyvinylchloride plastic tubing, and the plastic tubing may be encased within a protective sleeve. Gas conduit 350 may be elastically deformable to accommodate the movement of linear actuators 170 and garment 110.

Control valves 330 regulate a flow of pressurized gas from compressed gas tank 340 to linear actuators 170. For instance, each of linear actuators 170 may be associated with a respective control valve 330. Controller 310 may open one of control valves 330 to allow pressurized gas from compressed gas tank 340 to flow into a respective linear actuator 170. The pressurized gas within the linear actuator 170 may cause the linear actuator 170 to contract. Conversely, controller 310 may close the one of control valves 330 to terminate a flow of pressurized gas from compressed gas tank 340 into the respective linear actuator 170. Linear actuator 170 may contract in response to the termination of the flow of pressurized gas into the linear actuator 170. As may be seen from the above, controller 310 may selectively contract and expand linear actuators 170 by opening and closing control valves 330. Control valves 330 may be three-position solenoid gas valves or digital proportional pressure regulators, in certain example embodiments.

As particular example, controller 310 may receive signals from sensors 320, and controller 310 may calculate a target stroke length of each of linear actuators 170 based at least in part on a motion, limb pose, and joint angles of pressurized spacesuit 100 measured by sensors 320. Based upon the target stroke lengths, controller 310 may open and/or close control valves 330 to implement a respective target stroke length at each of linear actuators 170.

As may be seen in FIG. 10, an outlet of linear actuators 170 may be connected to compressed gas tank 340. Thus, gas conduit 350 may form a loop between linear actuators 170 and compressed gas tank 340. Exo-muscular system 120 may also include a compressor 342 connected to the loop formed by gas conduit 350. Compressor 342 may be operable to increase the pressure of gas within gas conduit 350 and to flow such compressed gas into compressed gas tank 340. Thus, compressor 342 may operable to fill compressed gas tank 340 with compressed gas for operating linear actuators 170.

In another example of linear actuators arranged in a bi-articular or similar configuration, second end portions 177,179 of linear actuators 172, 174 may be coupled directly to each other at an end portion (e.g., elbow or knee joint) of second or fourth portions 140, 142. Mechanical coupling may be in the form of a sprocket and chain, or a similar power transmission mechanical linkage, where one end of the chain connects to the second end portion 177 of one linear actuator 172 and the opposite end of the chain connects to the opposing linear actuator 174 at the second end portion 179. The radial sprocket may include an integrated optical rotary encoder which constantly measures the joint angle. Joint angle data may be transmitted to controller 310.

As may be seen from the above, pressurized spacesuit 100 includes features for integrating wearable robotic augmentation and/or enabling operation at a partial or full Earth atmospheric pressure. Pressurized spacesuit 100 may be configured for both intra-vehicular and extra-vehicular activity. Pressurized spacesuit 100 may be an anthropomorphic pressure vessel for preservation of a human operator in space or on a planetary body. Pressurized spacesuit 100 may include layers for thermal management, micrometeoroid protection, and pressure retention. Pressurized spacesuit 100 may also include a soft and/or rigid strength-augmenting robotic system, integrated either internally or externally of pressurized spacesuit 100. The strength-augmenting robotic system may be assembled in a bi-articular or similar configuration. The strength-augmenting robotic system may supplement a user applicable force in order to overcome joint torque and therefore increasing dexterity of pressurized spacesuit 100, e.g., when operating at a partial or full Earth atmospheric pressure. A network of sensors may be strategically incorporated into the pressurized spacesuit 100 for physiological monitoring and real-time measuring of limb pose and/or joint angles for achieving synchronous motion between the strength-augmenting robotic system and operator bodily movement.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A pressurized spacesuit, comprising:
a pressure retention garment comprising a joint pivotally coupling a first portion of the pressure retention garment and a second portion of the pressure retention garment, the pressure retention garment further comprising a bearing rotatably coupling one of the first and second portions of the pressure retention garment and the joint; and
an exo-muscular system connected to the pressure retention garment, the exo-muscular system comprising
a first linear actuator, a first end portion of the first linear actuator positioned at and coupled to the bearing, and
a second linear actuator, a first end portion of the second linear actuator positioned at and coupled to the bearing,
wherein the first end portion of the first linear actuator is spaced from the first end portion of the second linear actuator on the bearing.

2. The pressurized spacesuit of claim 1, wherein the first and second linear actuators comprise pneumatic artificial muscles.

3. The pressurized spacesuit of claim 1, wherein the first end portions of the first and second linear actuators are pivotally coupled to the bearing.

4. The pressurized spacesuit of claim 1, wherein the pressure retention garment further comprises an additional bearing, a second end portion of the first linear actuator positioned at and coupled to the additional bearing, a second end portion of the second linear actuator positioned at and coupled to the additional bearing, the second end portion of the first linear actuator spaced from the second end portion of the second linear actuator on the additional bearing.

5. The pressurized spacesuit of claim 1, wherein the first and second portions of the pressure retention garment are tubular.

6. The pressurized spacesuit of claim 1, wherein the bearing is annular.

7. The pressurized spacesuit of claim 1, wherein the pressure retention garment is configured to contain a full Earth atmospheric pressurization.

8. The pressurized spacesuit of claim 1, wherein the first and second portions of the pressure retention garments comprise a fabric shell.

9. The pressurized spacesuit of claim 1, wherein the first and second portions of the pressure retention garment comprise a plastic shell.

10. The pressurized spacesuit of claim 1, wherein the first end portion of the first linear actuator is positioned opposite the first end portion of the second linear actuator on the bearing.

11. The pressurized spacesuit of claim 1, wherein the first portion of the pressure retention garment is an upper arm casing, the second portion of the pressure retention garment is a lower arm casing, and the joint is an elbow joint.

12. The pressurized spacesuit of claim 11, wherein the bearing is annular.

13. The pressurized spacesuit of claim 1, wherein the first portion of the pressure retention garment is an upper leg casing, the second portion of the pressure retention garment is a lower leg casing, and the joint is a knee joint.

14. The pressurized spacesuit of claim 13, wherein the bearing is annular.

15. The pressurized spacesuit of claim 1, wherein the first and second linear actuators are positioned radially-equidistant from an axial centerline of the first portion of the pressure retention garment.

16. The pressurized spacesuit of claim 1, wherein the pressure retention garment further comprises an additional bearing, a second end portion of the first linear actuator coupled to the additional bearing, the additional bearing rotatably coupling the other of the first and second portions of the pressure retention garment and the joint.

17. The pressurized spacesuit of claim 1, wherein a second end portion of the first linear actuator is coupled directly to the second portion of the pressure retention garment.

18. The pressurized spacesuit of claim 17, wherein the second end portion of the first linear actuator is coupled directly to an outer hard-shell casing or to an integrated feature of a fabric casing.

19. The pressurized spacesuit of claim 1, wherein the pressure retention garment comprises an inner bladder and an outer fabric restraint web.

20. The pressurized spacesuit of claim 1, wherein the first and second portions of the pressure retention garment are micrometeoroid, puncture, impact, heat and fire-resistant.

21. The pressurized spacesuit of claim 1, wherein the exo-muscular system further comprises a controller and a plurality of sensors, the controller configured to operate the first and second linear actuators based at least in part on one or more signals from the plurality of sensors.

22. The pressurized spacesuit of claim 21, wherein the plurality of sensors comprises one or more of an electromyographic monitoring sensor, a pulmonary metabolic sensor, a thermal balance sensor, a force sensor, and an inertial sensor.

23. The pressurized spacesuit of claim 21, wherein the plurality of sensors is configured to measure motion, limb pose, and joint angles of the pressurized spacesuit.

24. The pressurized spacesuit of claim 23, wherein the controller is configured to calculate a target stroke length of each of the first and second linear actuators based at least in part on the measured motion, limb pose, and joint angles of the pressurized spacesuit.

25. The pressurized spacesuit of claim 23, wherein the plurality of sensors is integrated into the pressure retention garment at an inner surface of the pressure retention garment.

26. The pressurized spacesuit of claim 21, further comprising a compressed gas tank and a control valve, the compressed gas tank in fluid communication with the first and second linear actuators, the control valve operable to regulate a flow of gas from the compressed gas tank to one or both of the first and second linear actuators.

27. The pressurized spacesuit of claim 26, wherein the control valve is a three-position solenoid gas valve or a digital proportional pressure regulator.

28. The pressurized spacesuit of claim 1, wherein the exo-muscular system further comprises plastic tubing connected to a port of the first or second linear actuators.

29. The pressurized spacesuit of claim 28, wherein the plastic tubing is constructed of polyurethane, polyamide, or polyvinylchloride, and is encased within a protective sleeve.

30. The pressurized spacesuit of claim 1, further comprising a plurality of gas tanks coupled to an outlet of the first and second linear actuators, the plurality of gas tanks configured to collect gas expelled from the first and second linear actuators.
